(19) United States
(12) Patent Application Publication
(10) Pub. No.: US 2011/0094281 A1
(43) Pub. Date: Apr. 28, 2011

(54) SHOT-TREATMENT MACHINE AND A JIG FOR A SHOT-TREATMENT

(76) Inventor: Tadanobu Oyama, Aichi (JP)

(21) Appl. No.: 12/990,728

(22) PCT Filed: Sep. 29, 2009
(86) PCT No.: PCT/JP2009/067313

§ 371 Date: Jan. 10, 2011

(30) Foreign Application Priority Data
Sep. 30, 2008 (JP) 2008-252919

(51) Int. Cl. C21D 7/06; B25B 11/02

(52) U.S. Cl. 72/53; 29/760

(57) ABSTRACT

Disclosed is a compact shot-treatment machine that enables the quality of a shot treatment for a workpiece to be enhanced, having a tubular portion, without generating dents on the workpiece. The shot-treatment machine comprises a jig 1 having a plurality of axial members 22, each axial member to be passed completely through each tubular portion of one or more workpieces W for holding them, and is detachably mounted on the jig; an enclosure 2 for defining a projection chamber therein; a supporting means 3 for rotatably holding the jig 1 in the projection chamber; a projection device 7 for projecting shots to the workpieces W in the projection chamber; and a circulating mechanism 8 for collecting the shots projected from the projection device 7 and supplying them to the projection device 7.

### FIELD OF THE INVENTION

This invention generally relates to a shot treatment. More particularly, this invention relates to a shot-treatment machine suitable for a workpiece that has a tubular portion and also relates to a jig for use with it.

Conventionally, a treatment of a workpiece that has a tubular portion, e.g., a coil spring for use in an automobile or a machine tool, incorporates a shot-blasting process in which steel shots are impacted on the workpiece to remove any attached extraneous material such as oxidized scales, and a shot-peening process to enhance the strength of the workpiece to be shot peened. As used herein, the term “a shot-treatment machine” refers to, inclusively, a machine for carrying out the shot-blasting process and the shot-peening process.

Conventional shot-treatment machines include a tumbling- type machine in which a plurality of coil springs are thrown in a drum such that shots impact the coil springs while they are stirred by rotating the drum, and a conveyor-type machine in which a conveyor belt for conveying the coil springs one by one is combined with a roller for rotating the coil springs (see patent document 1).

### [Patent Document 1]

Japanese Patent No. 2,512,278

### DISCLOSURE OF THE INVENTION

### Problems to be Solved by the Invention

In these conventional shot-treatment machines, however, the tumbling-type machine often causes dents on the surfaces of the coil springs because of collisions among them and thus produces unsightly processed products. If the worst happens, any coil spring can cause a rupture originating in a dent on its surface when it is used as a product.

The conveyor-type machine can avoid the collisions among the coil springs, and thus the resulting dents, by a treatment of the coil springs one by one. However, because the coils springs are arranged linearly along the direction in which they are conveyed, such a shot-treatment machine tends to be very long.

Accordingly, the aims of the present invention are to provide a compact shot-treatment machine that improves the quality of the shot treatment without resulting in dents on a workpiece having a tubular portion, e.g., a coil spring, and to provide a jig for a shot treatment to use with the shot-treatment machine.

### Means to Solve the Problems

The shot-treatment machine for a shot treatment of a workpiece having the tubular portion of the present invention comprises:

a jig having a plurality of axial members, wherein each axial member is to be passed completely through each tubular portion of one or more workpieces for holding them, and is detachably mounted on said jig;

an enclosure for defining a projection chamber therein;

supporting means for rotatably holding the jig;

a projection device for projecting shots to said workpieces in the projection chamber; and

a collecting means for collecting the shots projected from the projection device and for supplying them to the projection device.

Further, a jig that is adapted to be arranged in a projection chamber in which a shot treatment is carried out, for holding a workpiece having a tubular portion, comprises:

a plurality of axial members, each axial member having a diameter less than the inside diameter of each tubular portion of each workpiece such that the axial member can be passed completely through each tubular portion of one or more workpieces for holding them;

a stopper that is provided to or near the one lower end of each axial member for preventing the held workpieces from falling off therefrom;

a holding member for holding the plurality of axial members by detachably mounting both ends of each axial member; and

a hanger mounted on the top portion of the holding member for detachably suspending the holding member in the projection chamber.

The shot-treatment machine and its jig of the present invention enable setting a plurality of workpieces, such as coil springs, each having a tubular portion in the jig, to prevent dents caused by collisions among the workpieces in the shot-treatment, to improve the stable quality of the shot treatment by an orderly arrangement of the workpieces, and to process many workpieces within a small space in a machine.

### BRIEF DESCRIPTION OF THE DRAWINGS

FIG. 1 is a schematic block-diagram of the shot-treatment machine of the first embodiment of the present invention.

FIG. 2 is a detailed view of the jig for the shot treatment of the present invention used for the shot-treatment machine of FIG. 1.

FIG. 3 is an illustrative diagram for mounting workpieces on the jig of FIG. 2.

FIG. 4 is a schematic block-diagram of a shot-treatment machine of another embodiment of the present invention.

### THE BEST MODE TO EMBODY INVENTION

Below the shot-treatment machine and its jig of the present invention will be explained by reference to the accompanying drawings. In the embodiment, a workpiece W that has a tubular portion may be, for example, a coil spring used in an automobile or a machine tool. The shot-treatment machine and its jig of the present invention may be applicable to, but is not limited to, a shot-blasting machine used for removing scales on the workpiece W or a shot-peening machine for shot peening the workpiece W.

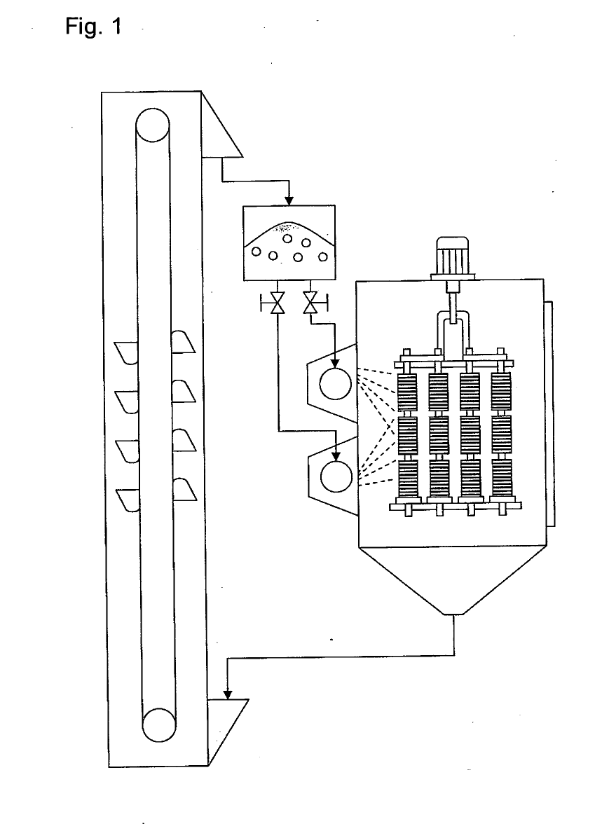

As in FIG. 1, the shot-treatment machine of the embodiment includes a jig 1 for shot treatment that can support one or more workpieces W, and an enclosure 2 within which a projecting chamber is defined, and for accommodating the jig 1. The enclosure 2 is a hermetically-closed box in which the inner faces of it are lined with abrasion-resistant liners made of cast steel or cast iron, to prevent shots S and dust from dispersing and leaking therefrom. The shot-treatment machine also includes a rotary supporting structure (supporting means) 3 that is attached to the enclosure 2 for rotatably holding the jig 1, an entrance door 6 that is placed in a side of the enclosure 2 to enable the workpieces W to be carried in and out from the enclosure 2 through it, a projecting device 7 that is installed in the enclosure 2 for accelerating and projecting the shots to the workpieces W, and a circulating mechanism (collecting means) 8 for collecting the projected shots S and for repeatedly supplying them to the projection device 7. The entrance door 6 is configured to enable it to be opened and closed by means of a hinge.

The rotary supporting-structure 3 is mounted on the top surface of the enclosure 2 and includes a hook 4 for suspending the jig 1 therefrom, and a geared motor 5 having an output shaft whose distal end is attached to the hook 4.

The circulating mechanism 8 for collecting the projected shots S includes a hopper 9 for collecting the projected shots S that are retained in the enclosure 2, a retaining hopper 10 for temporarily retaining the collected shots S, a bucket elevator 11 for conveying the collected shots S to the retaining hopper 10, and a supply pipe 12 for supplying the shots S to the projection device 7 from the retaining hopper 10.

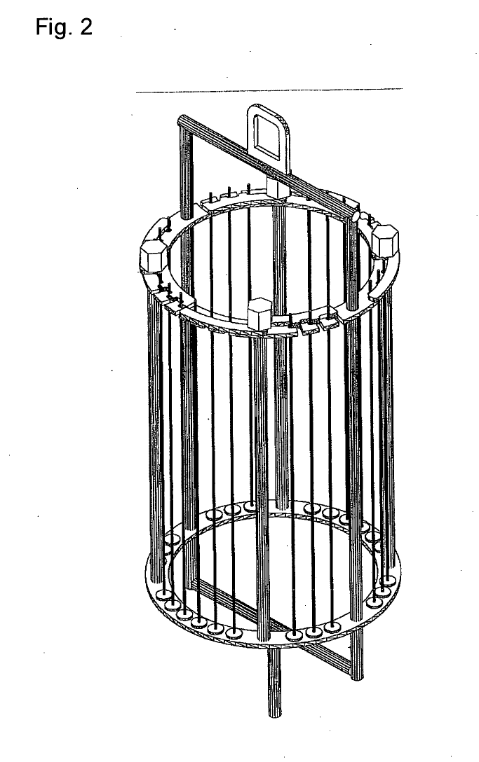

As in FIG. 2, the jig 1 includes a shaft 21. The shaft 21 includes an elongated axial member 22 that has a diameter less than the inside diameter of the tubular portion of the workpiece W such that the axial member 22 can be passed completely through each tubular portion of one or more workpieces S to hold them, and a stopper 23 that is attached to one end of the axial member 22 to prevent the held workpiece W from falling off the axial member 22. The jig 1 also includes a cage 24 in which a plurality of shafts 21 that hold the workpieces W in the above manner are detachably arranged, and a hanger 25 for suspending the cage 24 from a hook 4.

To prevent the workpieces W from falling off the axial members 22 of the respective shafts 21, each stopper 23 may be a circular plate or a star-shaped plate having a plurality of protrusions such that the outer diameter of each plate is the same as, or greater than, the outer diameter of each workpiece W.

To detachably mount the respective shafts 21 or their axial members 22 that hold the workpieces W, as shown in FIG. 2 the cage 24 includes upper and lower plates (holding members) 26 and 27, which are disposed at the respective ends of each shaft 21, and a plurality of connecting members 28 for connecting the upper plate 26 to the lower plate 27. The shape of the respective plates 26 and 27 may be circular, annular, or polygonal.

The upper plate 26 is provided with slits by circumferentially cutting it, to catch and hold one end of each shaft 21 therein. On the lower plate 27, a plurality of holes are bored along the circumference thereof to receive protruding portions of the respective axial members 22 that protrude through the respective stoppers 23.

The cage 24 may be a steel product with a coating to provide abrasion-resistance, if desired.

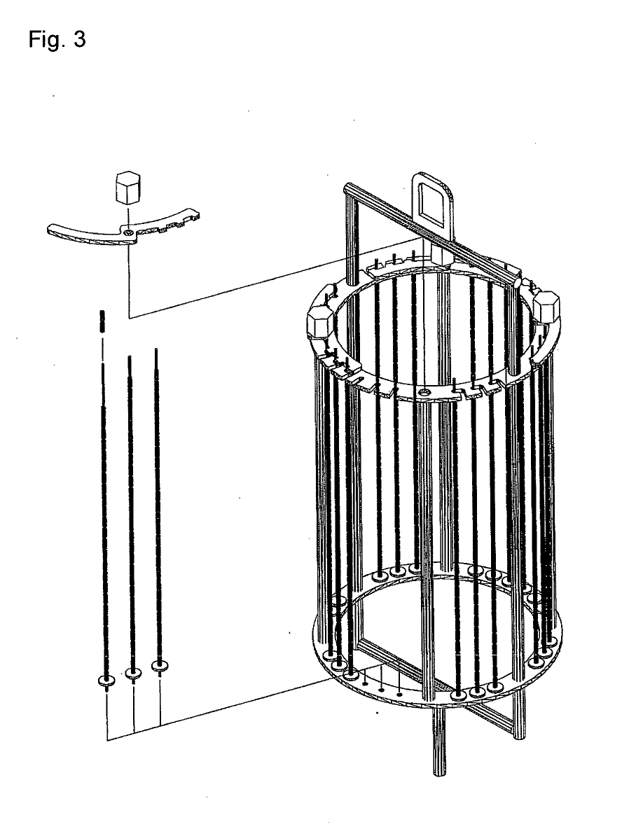

To set the workpieces W in the jig 1 outside the shot-treatment machine, as shown in FIG. 3 each axial member 22 of the corresponding shaft 21 is first passed completely through the workpieces W to hold them thereon. Each shaft 21, which holds the workpieces W, is then mounted in the cage 24 that is placed within the enclosure 2. The shaft 21 holding the completely passed-through workpieces W is then fixed by fixing a bracket 29 by means of a fastener (such as a bolt and a nut) 30.

In parallel with one shot-treatment being carried out, extra shafts 21 may be preferably provided such that their axial members 22 are passed completely through the corresponding tubular portions of the unprocessed workpieces W, to be late processed. By doing so, efficiencies in the shot-treatment can be further improved. Also, if the shaft 21 or the axial member 22 has worn out due to the shot-treatment, it can be readily replaced with a new one.

Further, an extra jig 1 may be preferably provided to enable completing a process in which the extra shafts 21 holding the unprocessed workpieces W are fixed to the extra jig 1 in parallel with the preceding shot-treatment being carried out. In this case, the following shot-treatment can be immediately begun by just replacing the jig 1 that is used for the preceding shot-treatment in the shot-treatment machine with the extra jig 1 to be used for the following shot-treatment.

The functions in respective parts of the shot-treatment machine will now be explained by means of the flow of the shots S.

The shots S are projected from the projection device 7 and process the workpieces W that are held and rotated by the jig 1. The projected shots S are then collected in the hopper 9 that is located in the lower part of the enclosure 2. In turn, the collected shots S are conveyed to the upper part of the shot-treatment machine by the bucket elevator 11 that communicates with the enclosure 2. The conveyed shots S are temporarily retained in the retaining hopper 10. The retained shots S are then re-supplied from the retaining hopper 10 through the supply pipe 12 by closing and opening a supply valve 31, which is installed in the middle of the supply pipe 12, to the projection device 7, to accelerate and project the supplied shots S therefrom.

Although the projection device 7 used in the embodiment is a centrifugal projection device in which rotating blades centrifugally accelerate the shots S, instead of it, an air-nozzle-type projection device in which the shots S are pressure-fed with compressed air to inject them from a nozzle may be used.

Although the circulating mechanism 8 in the embodiment employs the bucket elevator 11, instead of it, another means that enables the shots S to be conveyed, such as a screw conveyor or a conveyor belt, may be employed.

### EMBODIMENT

Examples of the treatment with the shot-treatment machine and the jig for it will now be explained. Note that the present invention is not limited to these examples.

In the examples, the workpiece W having the tubular portion was a coil spring. It was made of SUP material, and with φ 5.2 mm in the outer diameter, φ 4 mm in the inner diameter, and was 15 mm long. The shot-treatment machine of the present invention was used for removing oxidized scales resulting from a heat-treatment process after forming the coil spring.

In the examples, the axial member 22 of each shaft 21 was φ 1.6 mm in diameter and 500 mm in effective length such that twenty-six coil springs could be piled up along it. The shaft 21 could set twenty-four of them in one cage 24 such that they are arranged circularly at a position of φ 300 mm. The jig 1 for shot treatment was rotated at 28 rpm by means of the geared motor 5. The size of the shots S was φ 0.3 mm. As the projection device 7, two centrifugal projection devices were used such that the amount of the shots to be projected from each device was 120 kg/min. Under these conditions, the oxidized scales were able to be completely removed by the projection within 80 seconds.

In addition, dust produced by the process was collected by a dust collector (not shown), while large scales were transferred to the lower part of the bucket elevator 11 by means of a screw conveyer, which is not illustrated, but which was located under the hopper 9.

With the shot-treatment machine and the jig for it of the present invention, as should be understood from the foregoing descriptions, a plurality of workpieces W can be set in the jig 1 so as to prevent dents caused by the collisions among the workpieces W themselves in the shot-treatment, and to orderly arrange the workpieces W. This continuously improves the quality of the shot treatment and enables many of the workpieces W to be processed within a small space in the machine.

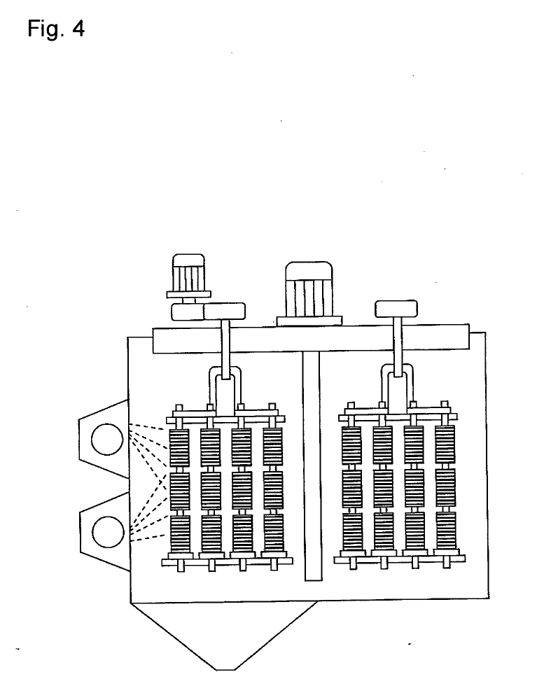

Further, in the shot-treatment machine as shown in FIG. 4, a plurality of jigs 1 may be provided. In this case, the inside of the enclosure 2 may be divided into a projection space 41 where the shots S are projected to the workpieces W to be processed and an entrance space 42 that opens up to a worker to enable carrying-in-and-out the workpieces W such that the jigs 1 are located in the respective spaces 41 and 42. In this arrangement, a shot-treatment and a process for carrying-in-and-out the workpieces W can be simultaneously carried out, to thus enhance the efficiencies in these processes.

On the shot-treatment machine described in the immediately above paragraph, a revolving ceiling 44, on which a plurality of jigs 1 can be arranged, is installed in a manner such that it can rotate by means of a revolving driving unit 43 such that the jigs 1 are sequentially located in the projection space 41 and the entrance space 42 by rotating the revolving ceiling 44. The jig 1, located in the projection space 41, can rotate during the shot treatment by coupling a drive pulley 46 that is coupled to a revolution/rotation treatment section 45 to a driven pulley 47 that is placed on the top of the jig 1.

With the shot-treatment machine and the jig for it of the present invention, a plurality of the workpieces in the jig can be set for the shot treatment, to prevent dents caused by the collisions among the workpieces in the shot-treatment, to improve the stable quality of the shot treatment by an orderly arrangement of the workpieces, and to process many workpieces within a small space in the machine. It is applicable to a mechanical part having a tubular portion such as a spacer or a bushing other than the coil spring of this embodiment.

Although the specified embodiments of the present invention are described with specified-materials and specified dimensions, it will be understood that they are not intended to limit the present invention. Obviously, various modifications and variations may be made without departing from the spirit of the invention by those skilled in the art.

1. A shot-treatment machine for a shot treatment a workpiece having a tubular portion comprising:
a jig having a plurality of axial members, each axial member to be passed completely through each tubular portion of one or more workpieces for holding them, and detachably mounted on said jig;
an enclosure for defining a projection chamber therein;
supporting means for rotatably holding said jig;
a projection device for projecting shots to said workpieces in said projection chamber; and
a collecting means for collecting the shots projected from said projection device and for supplying them to said projection device.

2. A jig that is adapted to be arranged in a projection chamber in which a shot treatment is carried out, for holding a workpiece having a tubular portion, comprising:
a plurality of axial members, each axial member having a diameter less than the inside diameter of each tubular portion of each workpiece such that said axial member can be passed completely through each tubular portion of one or more workpieces for holding them;
a stopper that is provided to or near the one lower end of each axial member for preventing the held workpieces from falling off therefrom;
a holding member for holding said plurality of axial members by detachably mounting both ends of each axial member; and
a hanger provided with the top portion of the holding member for detachably suspending said holding member in the projection chamber.
